(19) United States
(12) Patent Application Publication
(10) Pub. No.: US 2019/0256757 A1
(43) Pub. Date: Aug. 22, 2019

(54) COOLANT COMPOSITION

(71) Applicants: Yasuaki KODAMA, Seto-shi (JP); Hiroyuki ARAI, Toyota-shi (JP); Masayuki NAGASAWA, Toyota-shi (JP); Yoshimichi UMEHARA, Shizuoka-shi (JP); Yousuke KISHINO, Chiryu-shi (JP); Yu SASAKI, Shizuoka-shi (JP)

(72) Inventors: Yasuaki KODAMA, Seto-shi (JP); Hiroyuki ARAI, Toyota-shi (JP); Masayuki NAGASAWA, Toyota-shi (JP); Yoshimichi UMEHARA, Shizuoka-shi (JP); Yousuke KISHINO, Chiryu-shi (JP); Yu SASAKI, Shizuoka-shi (JP)

(73) Assignees: TOYOTA JIDOSHA KABUSHIKI KAISHA, Toyota-shi (JP); JAPAN CHEMICAL INDUSTRIES CO., LTD., Shizuoka-shi (JP)

(21) Appl. No.: 16/272,047

(22) Filed: Feb. 11, 2019

(30) Foreign Application Priority Data
Feb. 21, 2018 (JP) 2018-028938

(51) Int. Cl. C09K 5/20

(52) U.S. Cl. CPC C09K 5/20

(57) ABSTRACT

The present disclosure provides a coolant composition comprising acetate as a freezing-point depressant, which has low corrosiveness to metal such as aluminum and hardly deteriorates rubber. The present disclosure provides a coolant composition comprising water and acetate, wherein the coolant composition further comprises: an aliphatic polyol compound; an azole compound; at least one selected from phosphoric acid and a salt thereof; at least one selected from carboxylic acid and a salt thereof in an amount of 0.1% to 10% by weight, with respect to the total amount of the coolant composition; at least one selected from a calcium compound, a magnesium compound, and a strontium compound in an amount of 0.0001% to 0.2% by weight in terms of nitrate, with respect to the total amount of the coolant composition; and at least one selected from tartaric acid and a salt thereof in an amount of 0.001% to 1.0% by weight in terms of tartaric acid, with respect to the total amount of the coolant composition.

### CROSS REFERENCE TO RELATED APPLICATIONS

The present application claims priority from Japanese patent application JP 2018-028938 filed on Feb. 21, 2018, the content of which is hereby incorporated by reference into this application.

### BACKGROUND

### Technical Field

The present disclosure relates to a coolant composition.

### Background Art

As a coolant for cooling the internal-combustion engine, hybrid system, etc. of automobiles, a coolant comprising, as a freezing-point depressant for imparting anti-freezing properties to the coolant, glycols such as ethylene glycol or alcohols, has been used. For example, JP 2002-322467 A discloses a coolant composition comprising, as a main component, a melting-point depressant selected from alcohols and glycols. The coolant composition disclosed in JP 2002-322467 A is characterized in that it comprises at least one selected from phosphoric acid and an alkali metal salt thereof, at least one selected from a calcium compound and a magnesium compound, and at least one selected from 2-phosphonobutane-1,2,4-tricarboxylic acid and an alkali metal salt thereof, in addition to the melting-point depressant.

Meanwhile, J P 2003-505532 A discloses that a water-soluble liquid composition comprising a mixture of C₁-C₂ carboxylate and C₃-C₅ carboxylate exhibits an extremely low freezing point, and is also excellent in terms of heat transfer properties, in comparison to a composition comprising glycol as a freezing-point depressant.

U.S. Patent Application Laid-Open No. US 2007/0158612 A1 discloses an aqueous coolant composition comprising a C₆-C₁₆ organic salt corrosion inhibitor in combination with a C₃-C₅ carboxylate freezing-point depressant.

JP 2015-529267 A discloses a heat transfer fluid additive composition, comprising: approximately 10% by weight of carboxylate based on the total weight of the composition; an azole compound; a base; and water, wherein the base is present in an amount sufficient for that a pH value from approximately pH 7 to approximately 10.5 can be obtained when the heat transfer fluid additive composition is diluted with water to 50% by volume.

### SUMMARY

To date, a coolant composition comprising, as a main component, a base agent other than glycols has not been broadly used, although it has favorable heat transfer properties.

The conventional coolant composition comprising carboxylate disclosed in JP 2003-505532 A has good anti-freezing properties and heat transfer properties. However, the coolant composition of JP 2003-505532 A proposes pH in the alkaline range. In recent years, for the purpose of saving the weight of automobiles, aluminum or an aluminum alloy has been widely used in cooling components for the internal-combustion engines of automobiles, hybrid electric cars, etc. Accordingly, rapid progression of metal corrosion has become problematic.

The present inventors have found that a coolant composition comprising carboxylate as a main component of a freezing-point depressant thereof tends to easily deteriorate rubber.

In order to provide a coolant composition comprising acetate as a freezing-point depressant, wherein the coolant composition has low corrosiveness to metal and hardly deteriorates rubber without impairing anti-freezing properties, the present inventors have conducted intensive studies, thereby completing a coolant composition having the following characteristics.

The present disclosure provides a coolant composition comprising water and acetate, wherein the coolant composition further comprises:

an aliphatic polyol compound;

an azole compound;

at least one selected from phosphoric acid and a salt thereof;

at least one selected from carboxylic acid and a salt thereof in an amount of 0.1% to 10% by weight, with respect to the total amount of the coolant composition;

at least one selected from a calcium compound, a magnesium compound, and a strontium compound in an amount of 0.0001% to 0.2% by weight in terms of nitrate, with respect to the total amount of the coolant composition; and

at least one selected from tartaric acid and a salt thereof in an amount of 0.001% to 1.0% by weight in terms of tartaric acid, with respect to the total amount of the coolant composition.

The coolant composition of the present disclosure is advantageous in that it is excellent in terms of anti-freezing properties and heat transfer properties because it comprises acetate as a freezing-point depressant, and also in that it has low corrosiveness to metal and hardly deteriorates rubber. Acetate has been problematic in that it has particularly high heat transfer properties, compared to other lower carboxylates such as propionate, but it has strong metal corrosiveness. The coolant composition of the present disclosure can solve the aforementioned problem.

In one embodiment, the above-described coolant composition further comprises at least one selected from phosphonobutane tricarboxylic acid and a salt thereof, wherein the total amount of at least one selected from tartaric acid and a salt thereof and at least one selected from phosphonobutane tricarboxylic acid and a salt thereof, which are in terms of tartaric acid and phosphonobutane tricarboxylic acid, respectively, is 0.001% to 1.0% by weight, with respect to the total amount of the coolant composition.

The coolant composition according to the above-described embodiment comprises at least one selected from tartaric acid and a salt thereof in combination with at least one selected from phosphonobutane tricarboxylic acid and a salt thereof, which are sequestering agents, so that the coolant composition has particularly high anticorrosion properties to metal.

In one embodiment, the above-described coolant composition comprises at least one selected from glycerin, propylene glycol, and 1,3-propanediol as an aliphatic polyol compound.

The coolant composition according to the above-described embodiment can particularly significantly suppress deterioration of rubber, when it comes into contact with the rubber.

In another embodiment, the above-described coolant composition comprises the aliphatic polyol compound in an amount of 1.0% to 10% by weight, with respect to the total amount of the coolant composition.

In another embodiment, the above-described coolant composition comprises molybdate in an amount of 0.1% to 1.0% by weight in terms of sodium molybdate, with respect to the total amount of the coolant composition.

In another embodiment, the above-described coolant composition comprises the azole compound in an amount of 0.01% to 10% by weight, with respect to the total amount of the coolant composition.

In another embodiment, the above-described coolant composition comprises at least one selected from phosphoric acid and a salt thereof in an amount of 0.01% to 2.0% by weight in terms of phosphoric acid, with respect to the total amount of the coolant composition.

In another embodiment, in the above-described coolant composition, the carboxylic acid is at least one selected from monocarboxylic acid and dicarboxylic acid. In some embodiments, the monocarboxylic acid is particularly at least one selected from 2-ethylhexanoic acid, heptanoic acid, octanoic acid, and nonanoic acid. In some embodiments, the dicarboxylic acid is particularly at least one selected from azelaic acid, suberic acid, and sebacic acid.

The coolant composition according to each of the above-described embodiments can particularly significantly suppress corrosion of metal, when it comes into contact with the metal, and deterioration of rubber, when it comes into contact with the rubber.

The coolant composition comprising acetate as a freezing-point depressant of the present disclosure has low corrosiveness to metal and hardly deteriorates rubber.

### DETAILED DESCRIPTION

Hereinafter, the embodiments of the coolant composition of the present disclosure will be specifically described. However, the following embodiments are not intended to limit the present disclosure.

The coolant composition of the present disclosure comprises water and acetate, and further comprises other components as described later.

Acetate is mixed as a main component of a melting-point depressant into the coolant composition. The coolant composition comprising acetate has favorable heat transfer properties.

As such acetate, alkali metal salts of acetic acid can be used in some embodiments. As alkali metal salts, potassium salts, sodium salts, and lithium salts are used in some embodiments, and potassium salts are particularly used. The acetate may be a mixture of multiple types of salts.

The content of the acetate is not particularly limited. The acetate may be used in an amount of 10% to 50% by weight in some embodiments, and 20% to 45% by weight in other embodiments, in terms of potassium acetate, with respect to the total amount of the coolant composition. In the following explanation, the content of a certain component is indicated as a ratio (% by weight) with respect to the total amount of the coolant composition. That is to say, the total amount of the coolant composition is set at 100% by weight, and the content of each component is indicated based on the total amount of the coolant composition.

The content of water in the coolant composition of the present disclosure is not particularly limited. The water may be used in an amount of 40% to 85% by weight in some embodiments, and 50% to 85% by weight in other embodiments, with respect to the total amount of the coolant composition.

The coolant composition of the present disclosure is characterized in that it further comprises an aliphatic polyol compound as a melting-point depressant, in addition to the acetate. A coolant composition comprising only acetate as a melting-point depressant tends to deteriorate rubber, when it comes into contact with the rubber, and thereby, to reduce tensile strength. In contrast, a coolant composition further comprising an aliphatic polyol compound, as well as acetate, hardly deteriorates rubber, although it comprises the acetate, and thus, it is favorable.

The aliphatic polyol compound is not particularly limited, as long as it is an aliphatic hydrocarbon compound having two or more hydroxyl groups. It is an aliphatic hydrocarbon compound having typically 3 to 6 hydroxyl groups, and 3 or 4 hydroxyl groups in some embodiments, and further, 3 hydroxyl groups in some other embodiments. The number of hydroxyl groups is typically 2 to 4, and is 2 or 3 in some embodiments. A specific example of the aliphatic polyol compound is at least one selected from glycerin, propylene glycol (=1,2-propanediol), 1,3-propanediol, 1,3-butanediol, 1,5-pentanediol, and hexylene glycol. In some embodiments, the aliphatic polyol compound is at least one selected from glycerin, propylene glycol, and 1,3-propanediol.

The content of the aliphatic polyol compound in the coolant composition of the present disclosure is not particularly limited. The content of the aliphatic polyol compound is smaller than the content of the acetate in some embodiments. The content of the aliphatic polyol compound is 1.0% to 10% by weight in other embodiments, and is 2.0% to 8.0% by weight in further embodiments, with respect to the total amount of the coolant composition.

The coolant composition of the present disclosure further comprises an azole compound. The azole compound has the effect of preventing corrosion of copper.

Examples of the azole compound include a triazole compound and a thiazole compound. Examples of the triazole compound include benzotriazole and tolyltriazole. Examples of the thiazole compound include benzothiazole and mercaptobenzothiazole sodium. The azole compound may be a combination of multiple types of azole compounds.

The content of the azole compound in the coolant composition of the present disclosure is not particularly limited. The content of the azole compound is 0.01% to 10% by weight in some embodiments, and is 0.05% to 5.0% by weight in other embodiments, with respect to the total amount of the coolant composition.

The coolant composition of the present disclosure further comprises at least one selected from phosphoric acid and a salt thereof. It may also be a combination of two or more types of components selected from phosphoric acid and a salt thereof. The phosphoric acid and a salt thereof greatly contribute to suppression of the corrosion of aluminum and an aluminum alloy, and thus, the anticorrosion properties of aluminum are significantly improved under cavitation. As phosphate, the alkali metal salts of phosphoric acid are used in some embodiments, and the potassium salts, sodium salts, and lithium salts of phosphoric acid are used in other embodiments.

The content of at least one selected from phosphoric acid and a salt thereof in the coolant composition of the present disclosure is not particularly limited. The content of at least one selected from phosphoric acid and a salt thereof is 0.01% to 2.0% by weight in some embodiments, and is 0.05% to 0.5% by weight in other embodiments, in terms of phosphoric acid, with respect to the total amount of the coolant composition. When the content of at least one selected from phosphoric acid and a salt thereof is within this range, the anticorrosion properties of the coolant composition are particularly high.

The coolant composition of the present disclosure further comprises at least one selected from carboxylic acid and a salt thereof in an amount of 0.1% to 10% by weight in terms of carboxylic acid, with respect to the total amount of the coolant composition.

Carboxylic acid and a salt thereof are used to impart anticorrosion properties to metal to the coolant composition.

As monocarboxylic acid, aliphatic monobasic acid is used in some embodiments. As aliphatic monobasic acid, at least one selected from 2-ethylhexanoic acid, heptanoic acid, octanoic acid, and nonanoic acid is specifically used in some embodiments.

As dicarboxylic acid, aliphatic dibasic acid is used in some embodiments. As aliphatic dibasic acid, at least one selected from oxalic acid, malonic acid, succinic acid, glutaric acid, adipic acid, piperic acid, suberic acid, azelaic acid, sebacic acid, undecanoic diacid, dodecanoic diacid, brasylic acid, and thapsic acid is specifically used in some embodiments, and further, at least one selected from azelaic acid, suberic acid, and sebacic acid is particularly used.

As salts of carboxylic acid, the alkali metal salts of carboxylic acid are used in some embodiments. Examples of the alkali metal salts include sodium salts, potassium salts, and lithium salts, and among others, potassium salts are particularly used.

The content of at least one selected from carboxylic acid and a salt thereof in the coolant composition of the present disclosure is 0.1% to 5% by weight in some other embodiments, in terms of carboxylic acid, with respect to the total amount of the coolant composition.

The coolant composition of the present disclosure further comprises at least one selected from a calcium compound, a magnesium compound, and a strontium compound, in an amount of 0.0001% to 0.2% by weight in terms of nitrate, with respect to the total amount of the coolant composition nitrate.

A calcium compound, a magnesium compound, and a strontium compound have action to significantly suppress corrosion of metal, such as aluminum and an aluminum alloy, at a high temperature. Accordingly, these compounds prevent cavitation, erosion and corrosion occurring at a metal member consisting of aluminum, an aluminum alloy, etc., and thus, the anticorrosion properties of a heat transfer surface are improved at a high temperature.

Examples of such a calcium compound, a magnesium compound, and a strontium compound, which can be used herein, include nitrate, oxide, hydroxide, permanganate, chromate, fluoride, iodide, carbonate, sulfate, titanate, tungstate, borate, phosphate, dihydrogenphosphate, formate, acetate, propionate, butyrate, valerate, laurate, stearate, oleate, glutamate, lactate, succinate, malate, tartrate, maleate, citrate, oxalate, malonate, sebacate, benzoate, phthalate, salicylate, and mandelate.

The content of at least one selected from a calcium compound, a magnesium compound, and a strontium compound in the coolant composition of the present disclosure is 0.001% to 0.2% by weight in some embodiments, and is 0.002% to 0.1% by weight in other embodiments, in terms of nitrate, with respect to the total amount of the coolant composition.

By the way, it is likely that at least one selected from a calcium compound, a magnesium compound, and a strontium compound would lead to an increase in production costs and would form scale-like sediments in a coolant flow channel due to excessive addition thereof. Hence, the coolant composition of the present disclosure further comprises one or more selected from the after-mentioned tartaric acid and a salt thereof. Thereby, although the content of at least one selected from a calcium compound, a magnesium compound, and a strontium compound is decreased to 0.2% by weight or less, anticorrosion performance that is equivalent to or greater than in the case of a high content of these components can be obtained, and further, formation of sediments can be prevented.

The coolant composition of the present disclosure further comprises at least one selected from tartaric acid and a salt thereof in an amount of 0.001% to 1.0% by weight in terms of tartaric acid, with respect to the total amount of the coolant composition.

The tartaric acid and a salt thereof are mixed as sequestering agents into the coolant composition of the present disclosure, so that they further impart anticorrosion properties to metal to the present coolant composition of the present disclosure. As sequestering agents other than the tartaric acid and a salt thereof, polymeric carboxylic acid, such as polyacrylic acid, and phosphonobutane tricarboxylic acid have been known. Surprisingly, the present inventors have found that the coolant composition of the present disclosure, which comprises polyacrylic acid or phosphonobutane tricarboxylic acid, instead of one selected from the tartaric acid and a salt thereof, does not have sufficient anticorrosion properties to aluminum, but the coolant composition of the present disclosure comprising one selected from the tartaric acid and a salt thereof has particularly high anticorrosion properties to aluminum.

The salts of the tartaric acid may be the alkali metal salts of the tartaric acid, and may be, for example, one or more selected from sodium salts, potassium salts and lithium salts.

The content of at least one selected from tartaric acid and a salt thereof in the coolant composition of the present disclosure is 0.01% to 0.5% by weight in terms of tartaric acid, with respect to the total amount of the coolant composition, in some embodiments.

The coolant composition according to one embodiment of the present disclosure further comprises at least one selected from phosphonobutane tricarboxylic acid and a salt thereof.

The phosphonobutane tricarboxylic acid and a salt thereof are sequestering agents. As described above, a coolant composition, which does not comprise tartaric acid or a salt thereof but comprises phosphonobutane tricarboxylic acid or a salt thereof, does not have sufficient anticorrosion properties to aluminum. However, surprisingly, a coolant composition prepared by combining, as sequestering agents, at least one selected from tartaric acid and a salt thereof with at least one selected from phosphonobutane tricarboxylic acid and a salt thereof, has particularly high anticorrosion properties to aluminum, since synergistic effects are exhibited from the two types of sequestering agents.

As such phosphonobutane tricarboxylic acid, specifically, 2-phosphonobutane-1,2,4-tricarboxylic acid can be used.

The phosphonobutane tricarboxylate can typically be the alkali metal salts of phosphonobutane tricarboxylic acid, and can be, for example one or more selected from sodium salts, potassium salts, and lithium salts.

In the coolant composition according to one embodiment of the present disclosure, the content of at least one selected from phosphonobutane tricarboxylic acid and a salt thereof is 0.001% to 1.0% by weight in some embodiment, and is 0.01% to 0.5% by weight in other embodiments, in terms of phosphonobutane tricarboxylic acid, with respect to the total amount of the coolant composition. Moreover, in a further embodiment, the total amount of at least one selected from tartaric acid and a salt thereof and at least one selected from phosphonobutane tricarboxylic acid and a salt thereof is 0.001% to 1.0% by weight in some embodiments, and is 0.01% to 0.5% by weight in other embodiments, in terms of tartaric acid and phosphonobutane tricarboxylic acid, respectively, with respect to the total amount of the coolant composition.

In one embodiment, the coolant composition of the present disclosure further comprises molybdate, and in another embodiment, further comprises molybdate in an amount of 0.1% to 2.0% by weight in terms of sodium molybdate, with respect to the total amount of the coolant composition. Because the coolant composition of the present disclosure comprises molybdate in the aforementioned amount, anticorrosion properties to metal are further enhanced.

The molybdate is the alkali metal salts of molybdic acid in some embodiment, is the sodium salts, potassium salts or lithium salts of molybdic acid in other embodiments, and is sodium molybdate in some other embodiments. The molybdate may be a mixture of multiple types of salts.

The content of molybdate in the coolant composition of the present disclosure is 0.1% to 1.0% by weight in terms of sodium molybdate, with respect to the total amount of the coolant composition in some embodiments.

In one embodiment, the coolant composition of the present disclosure may further comprise nitrate. The nitrate has the effect of suppressing the pitting corrosion of aluminum. Examples of the nitrate may include sodium nitrate and potassium nitrate. In the embodiment in which the coolant composition of the present disclosure further comprises the nitrate, the content of the nitrate is not particularly limited. The content of the nitrate is 0.01% to 0.5% by weight in some embodiments, and is 0.05% to 0.4% by weight in other embodiments, in terms of sodium nitrate, with respect to the total amount of the coolant composition.

Furthermore, in one embodiment of the coolant composition of the present disclosure, amine salts, borate, nitrite, and silicate are not desirably comprised.

### EXAMPLES

Hereinafter, the embodiments of the present disclosure will be specifically described in the following examples. However, these examples are not intended to limit the present disclosure. It is to be noted that the symbol “%” used in the following examples indicates “% by weight,” unless otherwise specified.

### Experiment 1: Rubber Tensile Test

### (Test Conditions)

Test piece: H-NBR (hydrogenated nitrile rubber)

### Temperature: 120° C.

Testing time: 500 hours

### (Test Method)

A test piece consisting of H-NBR, which had been cut into the shape of a dumbbell, was immersed in a test solution with the composition of each of Comparative Example 1 and Examples 1 to 5, as shown in Table 1, and thereafter, the test was carried out at 120° C. for 500 hours.

The tensile strength of the test piece before immersion and at 500 hours after the immersion started was measured in accordance with JIS K 6251: 2010.

From the measurement values of tensile strength, a tensile strength change rate (%) was obtained according to the following equation:

$$Tensile strength change rate ( \% ) = \frac{\begin{matrix}Measured tensile strength values of three \\ test pieces after immersion ( mean value )\end{matrix}}{\begin{matrix}Measured tensile strength values of three \\ test pieces before immersion ( mean value )\end{matrix}} \times 100 - 100 \qquad [ Equation 1 ]$$

The composition of each test solution and the measurement results regarding the tensile strength change rate are shown in Table 1.

TABLE 1

| | | Comp. | | | | | |
|---|---|---|---|---|---|---|---|
| | Ingredient | Ex. 1 | Ex. 1 | Ex. 2 | Ex. 3 | Ex. 4 | Ex. 5 |
| Mixed amount | Azelaic acid | 1 | 1 | 1 | 1 | 1 | 1 |
| (wt %) | Benzotriazole | 0.5 | 0.5 | 0.5 | 0.5 | 0.5 | 0.5 |
| | Phosphoric acid | 0.13 | 0.13 | 0.13 | 0.13 | 0.13 | 0.13 |
| | Sodium molybdate | 0.3 | 0.3 | 0.3 | 0.3 | 0.3 | 0.3 |
| | Calcium nitrate | 0.0035 | 0.0035 | 0.0035 | 0.0035 | 0.0035 | 0.0035 |
| | Magnesium nitrate | 0.013 | 0.013 | 0.013 | 0.013 | 0.013 | 0.013 |
| | Phosphonobutane- | 0.02 | 0.02 | 0.02 | 0.02 | 0.02 | 0.02 |
| | 1,2,4-tricarboxylic acid | | | | | | |
| | Water | Balance | Balance | Balance | Balance | Balance | Balance |
| | Potassium acetate | 35 | 35 | 35 | 35 | 35 | 35 |
| | Propylene glycol | | 5 | 3 | | | |
| | 1,3-Propanediol | | | | 5 | 3 | |
| | Glycerin | | | | | | 5 |
| Test results | Tensile strength change rate (%) | −21.3 | 1.9 | −8.7 | 3.1 | −8.8 | 2.7 |

When compared with the test solution of Comparative Example 1 that did not contain an aliphatic polyol compound such as propylene glycol, 1,3-propanediol or glycerin, the effect of reducing deterioration of the tensile strength of the H-NBR test piece was observed in the test solutions of Examples 1 to 5 each containing an aliphatic polyol compound.

### Experiment 2: Heat-Transfer Corrosion Test

The amount of an aluminum test piece corroded by heat transfer in each test solution with the composition shown in Table 2 was evaluated by a method in accordance with ASTM D4340.

Each test solution with the composition shown in Table 2 was added into a device formed from an aluminum test piece and a glass cell, and a pressure of 193 kPa was then applied to the device. The test piece was heated to 135° C., and the test was carried out for 168 hours. The weight of the test piece was measured before and after the test, and the amount of the test piece corroded was then calculated according to the following equation:

$$Corroded amount ( mg \text{/} {cm}^{2} \text{/} week ) = \frac{[ \begin{matrix}( Weight of test pieces before test ) - \\ ( weight of test pieces after test ) + \\ ( blank weight loss )\end{matrix} ] \times 1000}{( Surface area of heat transfer surface )} \qquad [ Equation 2 ]$$

The composition of each test solution and the measurement results regarding the corroded amount are shown in Table 2.

TABLE 2

| | Comp. | Comp. | Comp. | Comp. | | | |
|---|---|---|---|---|---|---|---|
| Ingredient | Ex. 2 | Ex. 3 | Ex. 4 | Ex. 5 | Ex. 6 | Ex. 7 | Ex. 8 |
| Azelaic acid | 1 | 1 | 1 | 1 | 1 | 1 | |
| 2-Ethylbexanoic acid | | | | | | | 1 |
| Benzotriazole | 0.3 | 0.3 | 0.3 | 0.3 | 0.3 | 0.3 | 0.3 |
| Phosphoric acid | 0.13 | 0.13 | 0.13 | 0.13 | 0.13 | 0.13 | 0.13 |
| Propylene glycol | 5 | 5 | 5 | 5 | 5 | 5 | 5 |

| | | | | | | | |
|---|---|---|---|---|---|---|---|
| Alkali earth | Calcium nitrate | 0.004 | | | | | |
| metal | Magnesium nitrate | 0.013 | | | | | |
| | Strontium nitrate | | 0.005 | 0.005 | 0.005 | 0.005 | 0.005 |
| Sequestering | Phosphonobutane- | 0.02 | 0.02 | | | 0.01 | |
| agent | 1,2,4-tricarboxylic acid | | | | | | |
| | Tartaric acid | | | | 0.05 | 0.03 | 0.05 |
| | Polyacrylic acid | | | 0.004 | | | |

| | | | | | | | |
|---|---|---|---|---|---|---|---|
| Water | Balance | Balance | Balance | Balance | Balance | Balance | Balance |
| Potassium acetate | 35 | 35 | 35 | 35 | 35 | 35 | 35 |
| Corroded amount (mg/cm²/week) | −0.83 | −0.58 | −0.64 | −0.44 | 0.03 | 0.07 | 0.16 |

Potassium acetate was used as a base material, and the type of a sequestering agent to be mixed (phosphonobutane tricarboxylic acid, tartaric acid, or polyacrylic acid) was changed. Thereafter, a comparison was made in terms of anticorrosion properties to aluminum.

It was confirmed that Comparative Example 2 that did not contain a sequestering agent, and Comparative Examples 3, 4, and 5 comprising, as a sequestering agent, phosphonobutane tricarboxylic acid or polyacrylic acid alone, did not have sufficient anticorrosion effects.

Example 6 comprising tartaric acid alone as a sequestering agent showed favorable anticorrosion performance. Example 7 comprising, as a sequestering agent, a combination of phosphonobutane tricarboxylic acid with tartaric acid, was confirmed to have higher anticorrosion effects than Example 6, although the total amount of the sequencing agents in Example 7 was smaller than that in Example 6.

What is claimed is:

1. A coolant composition comprising water and acetate, wherein the coolant composition further comprises:
an aliphatic polyol compound;
an azole compound;
at least one selected from phosphoric acid and a salt thereof;
at least one selected from carboxylic acid and a salt thereof in an amount of 0.1% to 10% by weight, with respect to the total amount of the coolant composition;
at least one selected from a calcium compound, a magnesium compound, and a strontium compound in an amount of 0.0001% to 0.2% by weight in terms of nitrate, with respect to the total amount of the coolant composition; and
at least one selected from tartaric acid and a salt thereof in an amount of 0.001% to 1.0% by weight in terms of tartaric acid, with respect to the total amount of the coolant composition.

2. The coolant composition according to claim 1, which further comprises at least one selected from phosphonobutane tricarboxylic acid and a salt thereof, wherein
the total amount of at least one selected from tartaric acid and a salt thereof and at least one selected from phosphonobutane tricarboxylic acid and a salt thereof, which are in terms of tartaric acid and phosphonobutane tricarboxylic acid, respectively, is 0.001% to 1.0% by weight, with respect to the total amount of the coolant composition.

3. The coolant composition according to claim 1, which comprises, as an aliphatic polyol compound, at least one selected from glycerin, propylene glycol, and 1,3-propanediol.

4. The coolant composition according to claim 1, which comprises the aliphatic polyol compound in an amount of 1.0% to 10% by weight, with respect to the total amount of the coolant composition.

5. The coolant composition according to claim 1, which further comprises molybdate in an amount of 0.1% to 1.0% by weight in terms of sodium molybdate, with respect to the total amount of the coolant composition.

6. The coolant composition according to claim 1, which comprises the azole compound in an amount of 0.01% to 10% by weight, with respect to the total amount of the coolant composition.

7. The coolant composition according to claim 1, which comprises at least one selected from phosphoric acid and a salt thereof in an amount of 0.01% to 2.0% by weight in terms of phosphoric acid, with respect to the total amount of the coolant composition.

8. The coolant composition according to claim 1, wherein the carboxylic acid is at least one selected from monocarboxylic acid and dicarboxylic acid.
